(19) United States
(12) Patent Application Publication
(10) Pub. No.: US 2018/0273170 A1
(43) Pub. Date: Sep. 27, 2018

(54) TRANSFORMABLE UNMANNED AERIAL VEHICLE

(71) Applicant: Regents of the University of Minnesota, Minneapolis, MN (US)

(72) Inventors: Ruben Raphael D'Sa, Woodbury, MN (US); Nikolaos Papanikolopoulos, Minneapolis, MN (US); Devon Jenson, Eden Prairie, MN (US); Travis Henderson, Ham Lake, MN (US); John Kilian, Minneapolis, MN (US)

(73) Assignee: Regents of the University of Minnesota, Minneapolis, MN (US)

(21) Appl. No.: 15/927,847

(22) Filed: Mar. 21, 2018

Related U.S. Application Data
(60) Provisional application No. 62/474,401, filed on Mar. 21, 2017.

(51) Int. Cl. B64C 29/02; B64C 39/02; B64C 3/56; B64C 3/32; B64D 27/24; B64C 11/30; B64C 13/18

(52) U.S. Cl. CPC B64C 29/02; B64C 39/024; B64C 3/56; B64C 3/32; B64D 27/24; B64C 2201/162; B64C 13/18; B64C 2201/102; B64C 2201/06; B64D 2211/00; B64C 11/30

(57) ABSTRACT

An unmanned aerial vehicle (UAV) including wing sections and hinge assemblies. Each wing section includes an airfoil and a propulsion unit. The wing sections are arranged side-by-side, pivotably connected by the hinge assemblies to define an airframe module. The airframe module is transitionable between a fixed-wing state and a rotor state. In the fixed-wing state, the airframe module has an elongated shape extending between opposing, first and second ends. In the rotor state, the first end is immediately proximate the second end. With this construction, the UAV provides two distinct modes of flight (fixed-wing for low power flight, and rotor for high maneuverability flight (including hover)). The wing sections can carry solar cells and a battery. A maximum power point tracker (MPPT) can be provided for optimizing the match between the solar array and the battery. The propulsion unit can include a variable pitch propeller.

### CROSS REFERENCE TO RELATED APPLICATIONS

This Non-Provisional patent application claims the benefit of the filing date of U.S. Provisional Patent Application Ser. No. 62/474,401, filed Mar. 21, 2017, the entire teachings of which are incorporated herein by reference.

### STATEMENT REGARDING FEDERALLY SPONSORED RESEARCH OR DEVELOPMENT

This invention was made with government support under CNS1531330 awarded by the National Science Foundation. The government has certain rights in this invention.

### BACKGROUND

The present disclosure relates to unmanned aerial vehicles (UAVs). More particularly, it relates to UAVs operable in different platforms or shapes, and conducive, for example, to solar-powered flight.

The domain of UAVs has grown tremendously across a variety of disciplines in both academic and industrial settings, thanks in part to the availability of affordable sensors, actuators and flight controllers. The fundamental designs of UAVs have seen major leaps in development, most notably in the area of small-scale airframes with either fixed-wing or multi-rotor flight.

With advancements in motor performance, solar cell efficiency, and battery density, efforts have recently been made to leverage solar power collection into the UAV design. Several fixed-wing and flying wing systems have been developed that are capable of solar-powered flight. To achieve a number of design goals, the size of these aircraft range between 4 meters and 5.8 meters. The known solar-powered UAV systems have relatively high aspect ratio wings and, in order to meet multi-day flight design goals, have correspondingly long wingspans. One of the greatest challenges with fixed-wing aircraft, compounded by a low Reynolds number and high aspect ratio wings, is maneuverability.

In contrast to a fixed-wing platform, multi-rotor UAVs (e.g., quad copters) are commonly used in applications that require both high maneuverability and the ability to hold a fixed spatial position. Their applications range from identification in search-and-rescue to characterization of nitrogen deficiencies in corn fields. However, maneuverability and control come at the cost of high power consumption, resulting in short flight times. This in in contrast with the high efficiency, long-flight capable fixed-wing system.

### SUMMARY

The inventors of the present disclosure recognized that a need exists for an unmanned aerial vehicle design that addresses one or more of the above problems.

Some aspects of the present disclosure are directed toward an unmanned aerial vehicle (UAV) including a plurality of wing sections and a plurality of hinge assemblies. Each of the wing sections includes an airfoil and a propulsion unit. The wing sections are consecutively arranged side-by-side. Respective ones of the hinge assemblies pivotably connect immediately adjacent ones of the wing sections to define an airframe module. The airframe module is transitionable between a fixed-wing state and a rotor state. In the fixed-wing state, the airframe module has an elongated shape extending between opposing, first and second ends, the first end defined by a side of a first wing section of the plurality of wing sections and the second end defined by a side of a second wing section of the plurality of wing sections. In the rotor state, the side of the first wing section is immediately proximate the side of the second wing section. With this construction, the UAV provides two distinct modes of flight (fixed-wing for lower energy consumption flight, and rotor for high maneuverability flight (including hover flight)). In some embodiments, one or more (including all) of the wing sections carry or include a plurality of solar (photovoltaic) cells and a battery for powering a motor of the corresponding propulsion unit. In related embodiments, a maximum power point tracker (MPPT) module is provided for optimizing the match between the solar array and the battery, with the MPPT module optionally operating as a buck, boost, or buck-boost. In other embodiments, the propulsion unit includes a motor having a motor shaft and a propeller mounted to the shaft, with a pitch of the propeller relative to the shaft being variable, for example by operation of a second actuator.

### BRIEF DESCRIPTION OF THE DRAWINGS

FIG. 1A is a perspective view of a UAV in accordance with principles of the present disclosure and in a fixed-wing state;

FIG. 1B is a perspective view of the UAV of FIG. 1A in a rotor state;

FIG. 2A is a top view of the UAV of FIG. 1A (fixed-wing state);

FIG. 2B is a top view of the UAV of FIG. 1B (rotor state);

FIG. 3A is a perspective view of a hinge assembly useful with the UAV of FIG. 1A and in the fixed-wing state;

FIG. 3B is a perspective view of the hinge assembly of FIG. 3A in the rotor state;

FIG. 4A is a schematic side view of the hinge assembly of FIG. 3A in the fixed-wing state;

FIG. 4B is a schematic side view of the hinge assembly of FIG. 3A in the rotor state;

FIGS. 5A-5E are perspective views illustrating transitioning of the UAV of FIG. 1A from the rotor state to the fixed-wing state;

FIGS. 6A-6C are side views of forces and torques acting on the high assembly of FIG. 3A in transitioning between the fixed wing state and the rotor state;

FIG. 7 is a side view of a wing section of the UAV of FIG. 1A;

FIG. 8A is a graph of moment coefficient as a function of velocity from a simulation of a UAV incorporating the wing section of FIG. 7 and in a fixed-wing state;

FIG. 8B is a graph of moment coefficient as a function of angle of incidence from a simulation of a UAV incorporating the wing section of FIG. 7;

FIG. 9 is a simplified side view of a portion of a propulsion unit useful with the UAVs of the present disclosure;

FIG. 10 are perspective views of the UAV of FIG. 1A in the fixed-wing state and illustrating optional thrust control during flight;

FIG. 11 is a simplified representation of a front end view of another UAV in accordance with principles of the present disclosure and in a fixed-wing state;

FIG. 12 presents graphs of available power and energy over time during operation of a UAV in accordance with principles of the present disclosure;

FIG. 13 presents graphs of total available flight time and fixed-wing available energy as a function of total system mass during operation of a UAV in accordance with principles of the present disclosure;

FIG. 14 is a graph of rotor state flight time as a function of battery size during operation of a UAV in accordance with principles of the present disclosure;

FIG. 15 is a graph of operational state over time for different total UAV masses;

FIG. 16 is a perspective view of a component module useful with UAVs of the present disclosure;

FIG. 17 is a perspective view illustrating assembly of the component module of FIG. 16 to an airfoil;

FIG. 18 is a block diagram of an electrical, power and communication topology useful with the UAVs of the present disclosure;

FIG. 19 is a circuit diagram of a portion of a maximum power point tracker (MDPT) useful with the UAVs of the present disclosure;

FIG. 20A presents top views of modular UAVs in accordance with principles of the present disclosure, illustrating both a rotor stand and a fixed-wing state;

FIG. 20B illustrate modular pods or component modules in accordance with principles of the present disclosure;

FIG. 21 presents graphs of power optimization simulations from the Examples section;

FIG. 22 is a graph of electrical power as a function of propeller thrust derived from testing described in the Examples section;

FIG. 23 is a block diagram of solar cell and power electronics modeling described in the Examples section; and

FIG. 24 presents graphs of simulated tracking algorithm response to dynamic irradiance using the modeling of FIG. 23 and as described in the Examples section.

### DETAILED DESCRIPTION

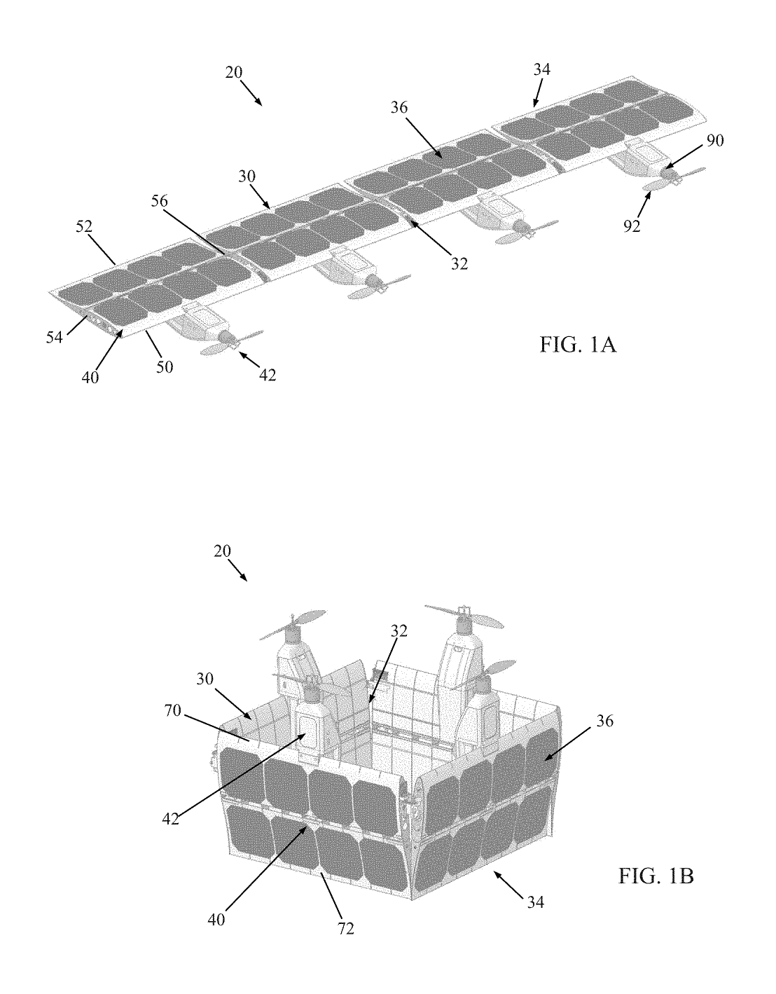

One embodiment of an unmanned aerial vehicle (UAV) 20 in accordance with principles of the present disclosure is shown in FIGS. 1A and 1B. The UAV 20 generally includes a plurality of wing sections 30 arranged in a side-by-side manner, with immediately adjacent ones of the wing sections 30 pivotably connected to one another by a hinge assembly 32 (one of which is represented and identified generally in FIGS. 1A and 1B) to collectively define an airframe module 34. With this pivotable connection, the airframe module 34 is configured to be transitionable between a fixed-wing state (FIG. 1A) and a rotor state (FIG. 1B). As described in greater detail below, the UAV 20 can include one or more actuators (not shown) that are commonly operated to effectuate arrangement in either the fixed-wing state or the rotor state. In some embodiments, one or more or all of the wing sections 30 include one or more solar or photovoltaic cells 36 (one of which is identified in FIGS. 1A and 1B), with the UAV 20 further including electrical and power management components adapted or programmed to facilitate long-term, high efficiency flight performance as described in greater detail below.

Airframe Module States and Transitioning

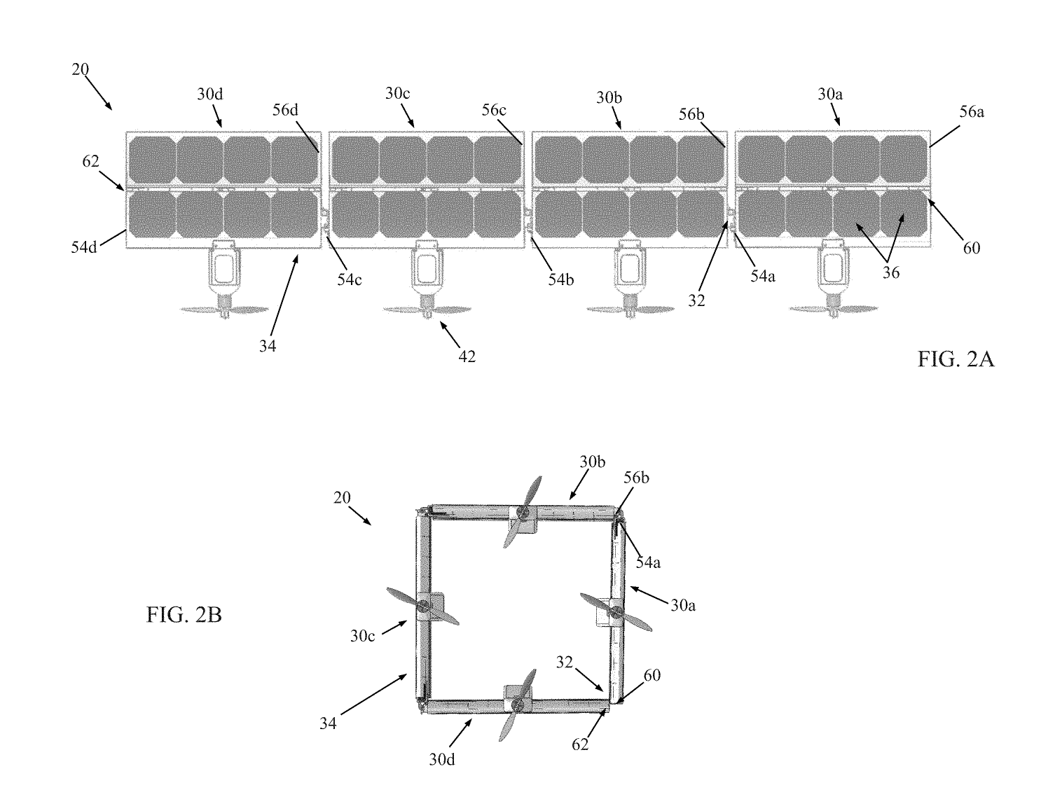

To facilitate an understanding of the airframe module 34 states and transitioning therebetween, it is initially noted that each of the wing sections 30 generally includes an airfoil 40 and a propulsion unit 42 mounted to the airfoil 40. The solar cell(s) 36 are secured to an outer surface of the airfoil 40. The airfoil 40 defines a leading end 50, a trailing end 52 opposite the leading end 50, a first side 54, and a second side 56 opposite the first side 54. The side-by-side arrangement of the wing sections 30 includes sides 54, 56 of immediately adjacent wing sections 30 being aligned with one another. For example, immediately adjacent, first and second wing sections 30a, 30b are identified in FIGS. 2A and 2B. The first side 54a of the first wing section 30a is aligned with the second side 56b of the second wing section 30b. The first and second wing sections 30a, 30b are pivotably connected to one another via the hinge assembly 32. With the non-limiting embodiment of FIGS. 2A and 2B, the airframe module 34 includes exactly four of the wing sections 30, with a third wing section 30c being immediately adjacent the second wing section 30b (opposite the first wing section 30a), and a fourth wing section 30d immediately adjacent the third wing section 30c (opposite the second wing section 30b). In the fixed-wing state (FIG. 2A), the airframe module 34 has an elongated shape spanning between opposing, first and second ends 60, 62 and conducive to fixed-wing flight. The first end 60 is provided by the first side 54d of the fourth wing section 30d; the second end 62 is provided by the second side 56a of the first wing section 30a. In the rotor state (FIG. 2B), the wing sections 30a-30d are articulated relative to one another as described below, bring the first and second ends 60, 62 (i.e., the first side 54d of the fourth wing section 30d and the second side 56a of the first wing section 30a) into close proximity to one another. In some embodiments, the UAV 20 includes an actuated clipping mechanism that releasably secures the ends 60, 62 in the rotor state. Regardless, a shape of the airframe module 34 is more compact in the rotor state (as compared to the fixed-wing state) and is conducive to multi-rotor (e.g., quad-rotor) flight.

The fixed-wing state presents the benefits of low power consumption flight (as compared to the rotor state), whereas the rotor state presents the benefits of high maneuverability (as compared to the fixed-wing state) as described in greater detail below. In addition, under normal flight conditions or orientations, a large surface area of the solar cells 36 is naturally presented for near optimal collection solar energy in the fixed-wing state. A general orientation of the UAV 20 under normal flight orientation relative to the sun is provided in FIGS. 2A (fixed-wing state) and 2B (rotor state). A comparison of FIGS. 2A and 2B illustrates that in the fixed-wing state, and enlarged surface area of the solar cells 36 is well positioned to collect solar energy, whereas in the rotor state, minimal solar energy collection is made which may not be enough to sustain flight.

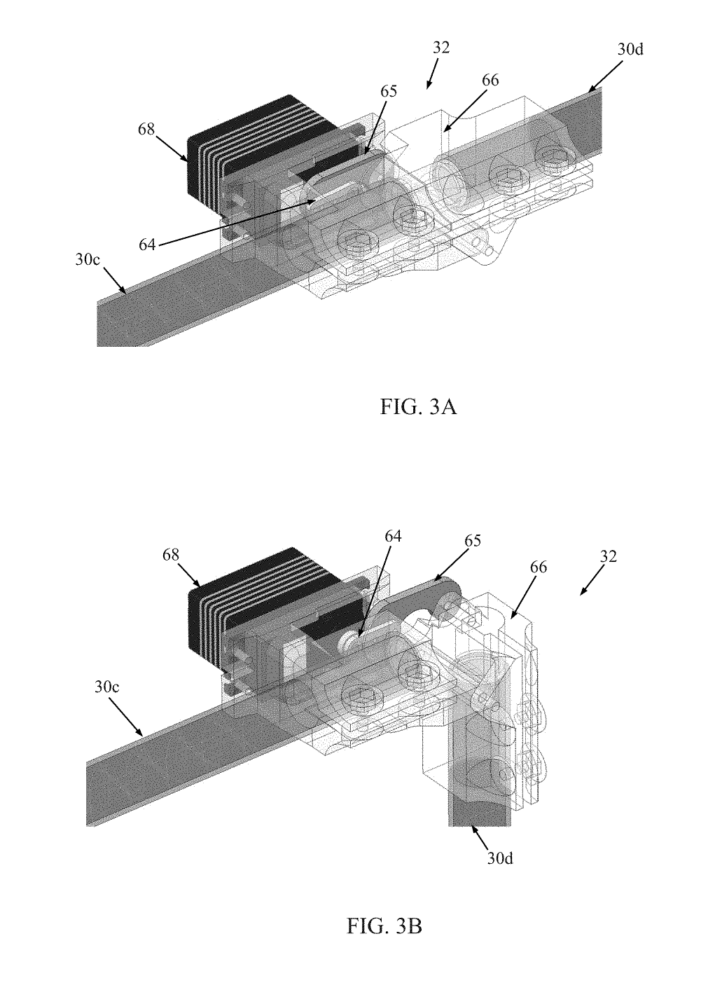

While the airframe module 34 has been described as having exactly four of the wing sections 30, in other embodiments, a greater or lesser number can be utilized. Further, in some embodiment, one or more of the wing sections 30 need not include a propulsion unit 42. To facilitate the transitions between the fixed-wing and rotor states, in some embodiments a plank flying wing geometry can be employed. This optional design approach allows for motor and propulsion system assemblies to be mounted at the same longitudinal position, as opposed to a staggered arrangement. To provide roll stability, the hinge assembly 32 provided between immediately adjacent ones of the wing sections 30 (e.g., between the first and second wing sections 30a, 30b) can have an active hinge design that is configured to transition the airframe module 34 between the fixed-wing and rotor states, and is designed to have a hard stop in one or both of the fixed-wing and rotor states. In some embodiments, the hinge design provides a plank geometry (0 degree angle) between immediately adjacent ones of the wing sections 30 in the fixed-wing state. One non-limiting example of the hinge assembly 32 connecting the third and fourth wing sections 30c, 30d is provided in FIGS. 3A and 3B, with FIG. 3A illustrating the fixed-wing state and FIG. 3B illustrating the rotor state. The hinge assembly 32 can assume various forms, and in some embodiments is an actuator-driven, double dead point four bar linkage hinge mechanism including an input link 64, a coupler link 65 and an output link 66. An actuator 68 drives the input link 65. The actuator 68 can be of a type known in the art, such as a servo motor actuator (e.g., a digital sport servo available from Hitec Multiplex under the trade designation HS-5625MG), linear actuator, etc. In some embodiments, a servo actuator is selected over a linear actuator due to speed of actuation at the consequence of lower overall output torque. The hinge assembly 32 is configured to generate 0 degree angle (i.e., plank wing) between the third and fourth wing sections 30c, 30d in the fixed-wing state, although other angular relationships are also acceptable (e.g., a dihedral angle of greater than 0 degrees can be established between the wing sections 30c, 30d in the fixed-wing state. Regardless, by configuring the hinge assembly 32 to have the built-in hard stop, actuator energy power consumption in the fixed-wing state can be minimized. With some embodiments in which the UAV utilizes 0 degree plank wing shape in the fixed-wing state, the hinge assembly 32 can be designed such that an entire 180 degrees sweep or range of the actuator input link 64 is mapped to 90 degrees by the four bar hinge mechanism, distributing the actuator's entire range of motion over the transformation process, thereby allowing for maximum utilization of actuator work as the entire input range is mapped to the output. Pivot points of the four bar hinge mechanism can be selected such that the deadpoints of the output link 66 occur at the fixed-wing state and the rotor state.

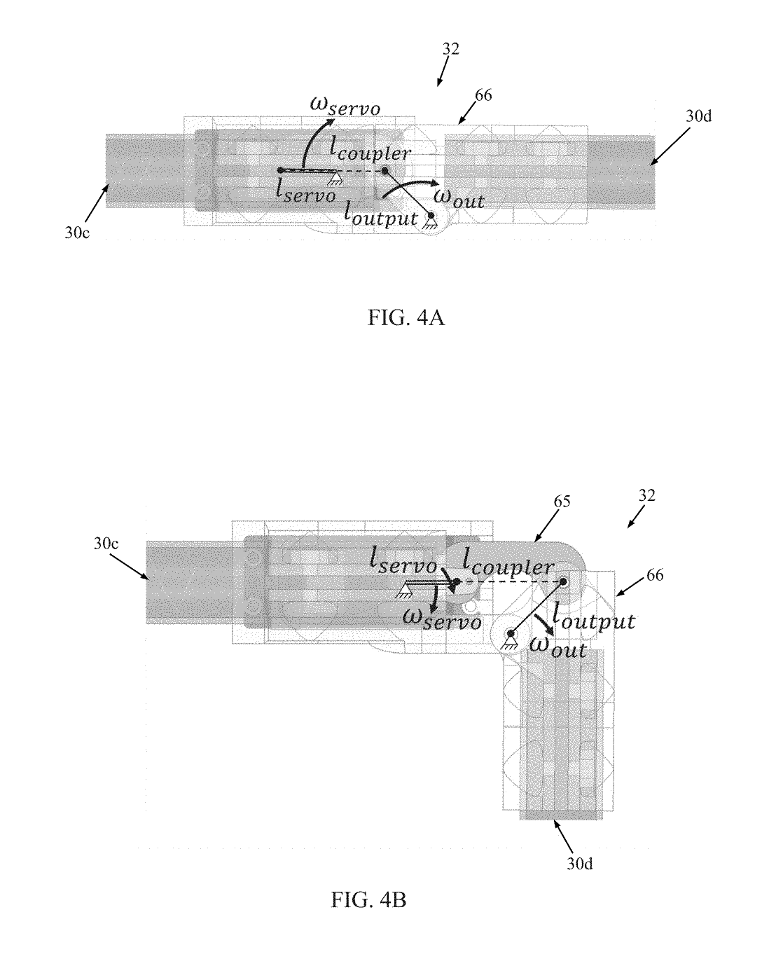

FIGS. 4A and 4B illustrate the hinge assembly 32 in the fixed-wing and rotor states, respectively, and identify angular velocities associated with transitioning from the fixed-wing state to the rotor state. In particular, ωₛₑᵣᵥₒ and ωₒᵤₜ represent the input and output angular velocity, respectively. Forming the hinge assembly 32 to include a four bar linkage has surprisingly been found to provide viable mechanical advantage and linkage angular velocity for effectuating actuated transitioning between the fixed-wing and rotor states while the UAV 20 (FIG. 1A) is airborne.

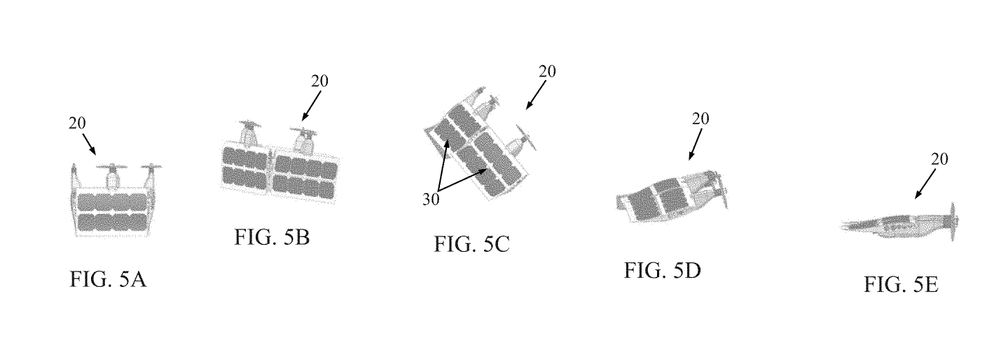

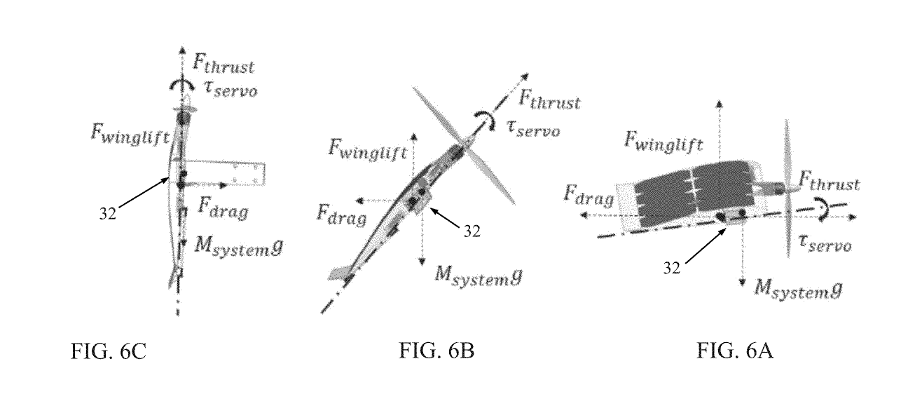

Returning to FIGS. 1A and 1B, other hinge assembly constructions are also envisioned that may or may not include a four bar mechanism. Further, the hinge assemblies 32 can be constructed to generate a dihedral or polyhedral angle between adjacent wing sections. With embodiments in which the hinge assemblies 32 include or are operated upon by an actuator, the UAV 20 can include one or more controllers programmed to operate the hinge assembly actuator(s) in a coordinated fashion. For example, automated control of the hinge assemblies 32 can be managed by a commercially available autopilot controller (e.g., a Pixhawk autopilot), toggling between each state by commanding the corresponding state positions through PWM. Regardless, and in some optional embodiments, the controller(s) operating the hinge assembly actuators can be programmed to effectuate a flight trajectory that minimizes hinge actuation torque when transitioning from the rotor state to the fixed-wing state (and vice-versa) to minimize a requisite size and mass of the hinge assembly actuators. For example, FIGS. 5A-5E sequentially illustrate an optional transition path from the rotor state to the fixed-wing state that the controller can be programmed to perform. By flying the UAV 20 in a near vertical state, the gravitational forces acting on the wing sections 30 are oriented nearly parallel to the axis of hinge rotation, thereby minimizing the torque required for actuation. When transitioning from the fixed-wing state to the rotor state, the air resistance of the wing section 30 will resist transition. To address this, the controller(s) can be programmed, as part of a fixed-wing to rotor state transition operation, to effectuate a flight trajectory that minimizes the translational velocity of the UAV 20. As represented by FIGS. 6A-6C (side views identifying forces and torques acting on the active hinge assembly 32 during transition between fixed-wing and rotor states), the air resistance force can thus be reduced. Other programmed flight trajectories are also acceptable. Moreover, in some embodiments, the UAVs of the present disclosure can be configured to transition between fixed-wing and rotor states without an active hinge. This can be done by programming the UAV to perform a trajectory that will force the UAV between the rotor and fixed-wing states; each state can be held in place using a locking mechanism at each pivot. Alternatively or in addition, elastic bands, springs, etc., could be used to toggle between states.

Wing Section 30

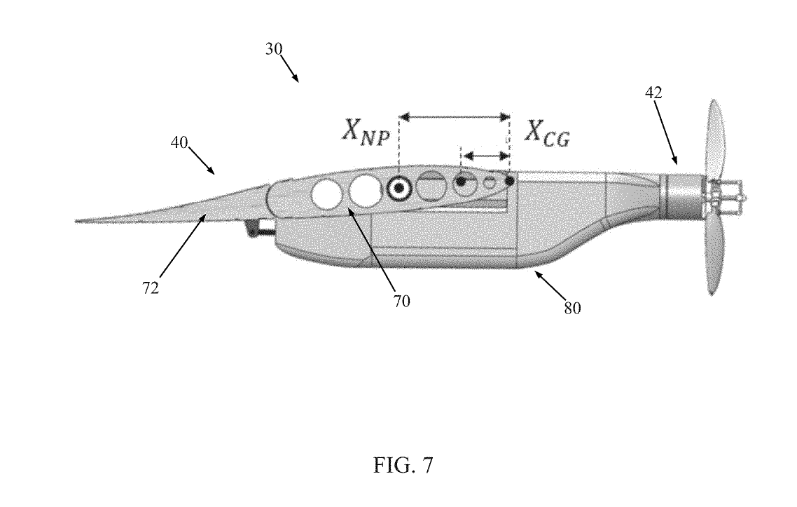

Returning to FIGS. 1A and 1B, the wing sections 30, including the airfoil 40 and the propulsion unit 42, can assume a variety forms that facilitate the airframe module 34 states and transitions described above. For example, the airfoil 40 can have any shape or construction conducive to flight (e.g., an MH49 airfoil from MH-AeroTools), and can include an airfoil body 70 and a flap or tail or control surface 72 that can be articulated relative to the body 70. As shown in FIG. 7, in some constructions the airfoil 40 is a reflexed chord line airfoil. By using a reflexed chord line airfoil and adjusting the center of gravity of the wing section 30 (via construction and arrangement of components assembled to the airfoil 40, such as the propulsion unit 42) to be in front of the neutral point (nose heavy), the reflexed tail section 72 of the airfoil 40 will counter the pitching moment induced by the center of gravity and create a stable equilibrium point in the fixed-wing state. As a point of reference, FIG. 7 generally reflects the propulsion unit 42 as being provided with or carried by a component module or pod 80 that is mounted to the airfoil 40. As described below, additional components (e.g., electronics) can also be carried within the component module 80. Regardless, the center of gravity of the wing section 30 is a function of mass and shape of the airfoil 40 and the component module 80 (including the propulsion unit 42). With this in mind, the side profile view of FIG. 7 identifies a location (X_{NP}) of the neutral point (NP) and a location (X_{CG}) of the center of gravity (CG) of the wing section 30. As shown, the center of gravity CG is in front of the neutral point NP.

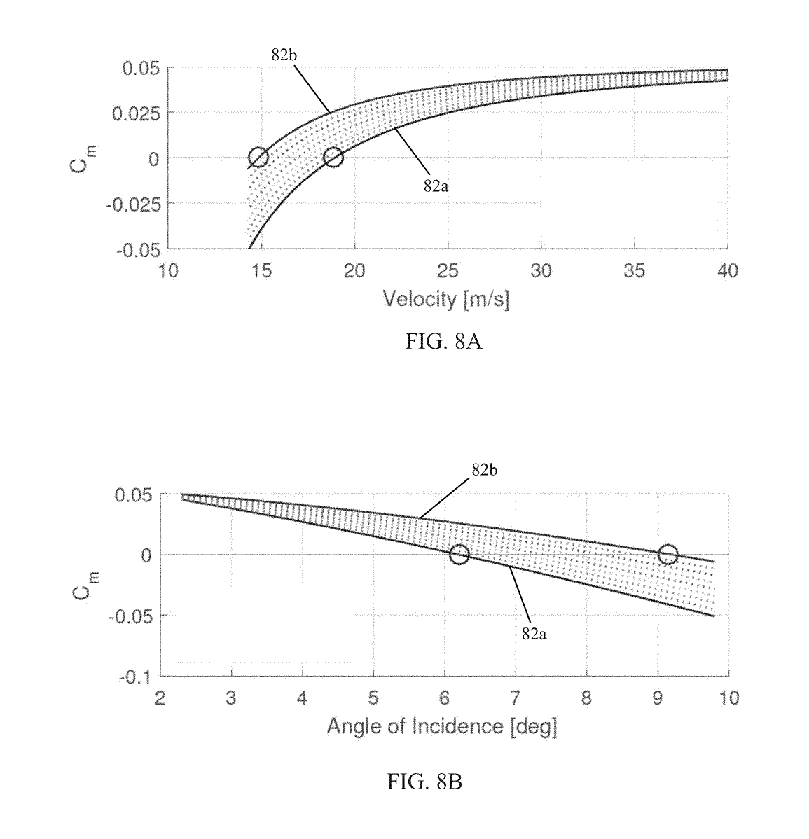

In some embodiments, the wing section 30 can be configured to provide a selected or pre-determined location of the center of gravity CG relative to the neutral point NP. As the location of the center of gravity CG moves further away from the neutral point NP, the necessary cruise velocity for level flight increases, raising the power consumption and hardware requirements of the propulsion unit 42. Further, the pitch stability increases, requiring a larger control surface. In some embodiments, in order to minimize the area of the wing section 30 that is unable to be covered by solar cells, the center of gravity CG can be adjusted to minimize the necessary control surface area while still providing adequate control authority. Moving the center of gravity CG closer to the neutral point NP reduces the necessary cruise velocity at the expense of pitch stability in turbulent conditions. In accordance with some aspects of the present disclosure, the wing section 30 can be designed or customized to provide a relationship between the center of gravity CG and the neutral point NP and/or an orientation of the airfoil 40 relative to the propulsion unit 42 in accordance with expected (or various) operating conditions. FIG. 8A is an example of moment coefficient Cₘ with respect to velocity of the airframe module 34 of FIG. 1A in the fixed-wing state generated by a simulation using vertex lattice method fixed lift analysis with a constant system mass of 4.943 kg. The center of gravity location (X_{CG}) is measured with respect to the leading edge of the airfoil with positive distance in the direction of the trailing edge. The open circles in FIG. 8A highlight the point where the airframe module with a given center of gravity location will fly (in the fixed-wing state) at a level altitude due to neutral pitching moment. FIG. 8B is an example of moment coefficient Cₘ with respect to angle of incidence for the same simulation. In FIGS. 8A and 8B, plot line 82a represents a center of gravity location (X_{CG}) of 0.036 m; plot line 82b represents a center of gravity location (X_{CG}) of 0.062 m. From the exemplary plot of FIG. 8B, it is possible to determine, given a particular center of gravity location X_{CG}, a necessary angle of incidence between the propulsion unit and the airfoil to provide a neutral pitching moment.

Returning to FIGS. 1A and 1B, in some embodiments other design and/or performance parameters can be utilized in configuring one or more or all of the wing sections 30. For example, in order to find the operating points that maximize energy performance of the UAV 20, the vertex lattice method (VLM) mentioned above can be employed. In some embodiments, an iterative approach can be taken between adjusting component placement and the resulting global pitching moment.

The airfoil 40 can be constructed of various materials appropriate for efficient flight in both the fixed-wing and rotor states as known to one of ordinary skill. In some embodiments, a size and shape of the airfoil 40 is selected to accommodate dimensions of a desired array of the solar cells 36. In this regard, the array of solar cells 36 can assume a wide variety of forms as known in the art. Useful solar panel cell formats include, but are not limited to, amorphous silicon, crystalline silicone, cadmium telluride, copper indium gallium selenide, gallium arsenide, etc. While the airfoil 40 of each of the wing sections 30 is illustrated in FIGS. 1A and 1B as being sized and shaped to accommodate or carry eight of the solar cells 36 (e.g., solar cells available from SunPower Corp. under the trade designation C60 or E60), any other number (or solar cell footprint dimension) is equally acceptable.

Propulsion Unit

The propulsion unit 42 of each of the wing sections 30 can assume a variety of forms, and in some embodiments includes a motor 90 rotatably driving a propeller 92 (labeled for one of the wing sections 30 in FIGS. 1A and 1B). The motor 90 can assume any form appropriate for generating desired rotational torque and speed, for example motors understood by those of ordinary skill as being useful with UAVs (e.g., a brushless multi-rotor motor available from DYS under the trade designation Quanum MT 2815 (880 KV)). In some embodiments, the propulsion unit 42 can be a motorized propeller system conventionally used with UAVs, including the propeller 92 having a fixed pitch relationship relative to the rotating shaft of the motor 90. In other embodiments, a variable pitch design can be provided. As a point of reference, the goal in designing a conventional, single-mode (i.e., fixed-wing only), solar-powered aircraft is to optimize the aircraft's efficiency close the characteristic operating point, usually level flight. In contrast, with the UAVs of the present, the introduction of a second characteristic operating point (i.e., fixed-wing state flight and rotor state flight) creates an enlarged flight envelope, and fixed-geometry propeller propulsion systems may not efficiently meet the associated propulsion demands. While it possible for a conventional fixed-wing UAV motorized propeller propulsion system (i.e., fixed pitch propeller) to be useful with the UAVs of the present disclosure, in some instances the UAV characteristic flight conditions will occur at the extremities of the propeller's performance data; in at least one of the predominant modes of flight (e.g., level flight, hovering, etc.), a fixed-geometry propeller inefficiently produces thrust.

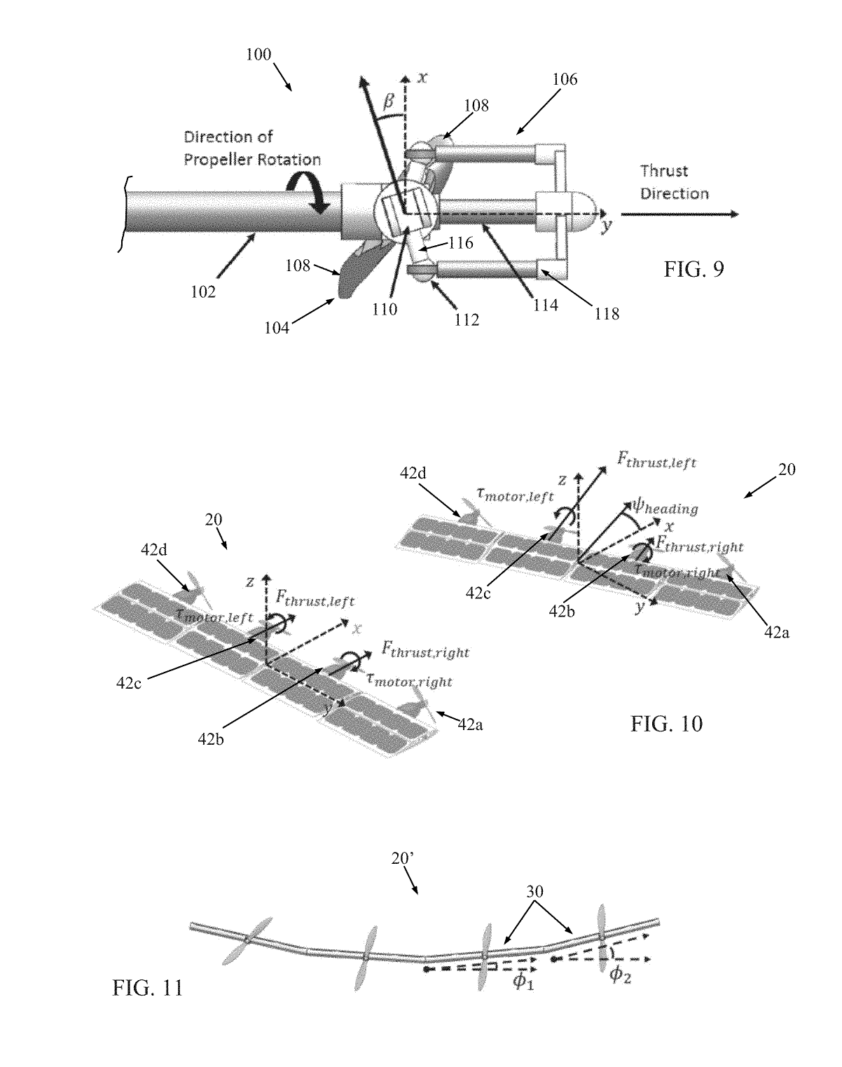

To address the above concerns, some propulsion units of the present disclosure are configured to incorporate a variable pitch propeller. Portions of an optional propulsion unit 100 useful with the UAVs of the present disclosure are shown in FIG. 9. The propulsion unit 100 includes a motor shaft 102, a propeller 104 and a variable pitch control mechanism 106 (referenced generally). The motor shaft 102 is provided as part of a motor (not shown) that operates to rotate the motor shaft 102. The propeller 104 includes blades 108. The control mechanism 106 is operable to effectuate a change in a pitch of the blades 108 relative to a central axis (y) of the motor shaft 102 (identified in FIG. 9 as propeller blade pitch β or angle through which a fixed pitch propeller blade must be rotated in order to achieve a desired orientation). In some embodiments, the control mechanism 106 can include a propeller mount 110, a linkage 112 (referenced generally), and a pushrod 114. The propeller mount 110 maintains the propeller 104 relative to the motor shaft 102 in a manner permitting selective articulation of the blades 108 to a desired pitch angle. The linkage 112 can include one or more first arms 116 and one or more second arms 118. The first arms 116 project from the mount 110 and are linked to a corresponding one of the second arms 118 in a manner allowing pivoting movement (e.g., a ball joint connection as shown). The second arms 118, in turn, are connected to the pushrod 114 that is otherwise concentric with the motor shaft 102. With this construction, movement of the pushrod 114 relative to the motor shaft 102 (e.g., actuated movement along the central axis y) effectuates a change in the blade pitch angle β. Other variable pitch control mechanisms can alternatively be employed.

The aerodynamic characteristics of a propeller are defined primarily by its three-dimensional geometry. Combining this geometric knowledge with the magnitude and direction of airflow past the propeller blades allows a complete propulsive description of the propeller's state to be specified. The variable pitch construction of FIG. 9 introduces a second degree of freedom (e.g., varying the propeller's pitch) that overcomes the possible limitations of fixed geometry propellers. In addition to a variable propeller speed, the conventional two-degree-of-freedom system can be varied in order to find the point at which a thrust constraint is satisfied at minimal energy cost.

Returning to FIGS. 2A and 2B, regardless of the propeller design, in some embodiments the direction of rotation of the propellers 92 alternates across the wing sections 30 to manage the torque produced by each propulsion unit 42. For example, the propeller 92 of the first and third wing sections 30a, 30c are caused to rotate in a first direction, whereas the propeller 92 of the second and fourth wing sections 30b, 30d are caused to rotate in an opposite, second direction such that the net induced toque by the propulsion units 42 is balanced in both the fixed-wing and rotor states.

Differential Thrust

In some embodiments, the UAVs of the present disclosure can be configured to incorporate or implement differential thrust protocols as part of an in-flight control system, for example in the fixed-wing state. As a point of reference, with embodiments in which the fixed-wing state is, or is akin to, a plank-type airframe, while excellent roll stability is achieved, the lack of vertical fins may present yaw drift and slide slip challenges during flight. Optionally, a proportional-integral differential thrust controller can be implemented to address these concerns, regulating thrust at each of the active propulsion units 42. For example, FIG. 10 illustrates application of a differential thrust control approach for the UAV 20 in a fixed-wing state under side slip conditions. With the optional representations of FIG. 10, the inner two propulsion units 42b, 42c are actively powering the UAV 20 during flight in the fixed-wing state (whereas the outer two propulsion units 42a, 42d are inactive). Using the flight controller's state estimation, the aircraft yaw rate can be damped by actively varying the throttle on each of the two active propulsion units 42b, 42c. As the estimated heading devices from the heading setpoint by the angle ψ, throttle is increased to counter rotation about the z-axis. By increasing the thrust from one of the active propulsion units 42c while keeping the thrust from the other active propulsion unit 42b constant, a moment about the UAVs 20 z-axis is induced. Additionally, roll and pitch inputs can be mixed into the flight controller to perform coordinated turns. Other fixed-wing state flight control approaches are also acceptable.

Power and Energy Management

Power can be provided to the propulsion unit 42 of each wing section 30 in various manners. In some embodiments, each wing section 30 includes or carries one or more batteries and solar power circuitry. Additional electrical connections and components can further be provided that deliver energy from the battery(ies) and/or the solar cells 36 to the corresponding propulsion unit 42 in a desired manner; in related embodiments, the battery(ies) can have a rechargeable construction and appropriate circuitry is also included that electrically connects the solar cells 36 to the battery(ies). With this in mind, in some embodiments of the present disclosure, the UAV 20 incorporates an energy framework model that manages power delivery to the propulsion units 42.

One non-limiting model for power levels and energy management considers differences in possible solar energy collection and power consumption during UAV operation in the fixed-wing state and in the rotor state, and can be viewed as a hybrid model. More particularly, the hybrid model can consist of three states: fixed-wing, rotor, and ground. The differences in lift generation between the fixed-wing and rotor states provide a trade-off between power consumption and maneuverability. In the ground state, the UAV charges on the ground, typically in a fixed-wing orientation to maximize solar power intake. The equations below form the basis of the model.

During level flight in the fixed-wing state, power consumption can be determined by Equation (1) as:

$${P}_{fixed} ( {m}_{total} ) = \frac{{P}_{level}}{{η}_{prop}} = \frac{1}{{η}_{prop}} \cdot \frac{{C}_{D}}{{C}_{L}^{\frac{3}{2}}} \cdot \sqrt{\frac{2 {( {m}_{total} \cdot g )}^{3}}{ρ \cdot {A}_{wing}}} \qquad ( 1 )$$

where ηₚᵣₒₚ is the propulsion unit or system efficiency, C_{D} and C_{L} are the drag and lift coefficients that minimize level flight power, mₜₒₜₐₗ is the total UAV mass (including energy storage and payload mass), g is the acceleration of gravity, ρ is the air density at a constant altitude, and A_{wing} is the wing reference area.

In the rotor state, the power consumed during hover conditions can be determined by Equation (2) as:

$${P}_{rotor} ( {m}_{total} ) = {C}_{rotor} \cdot {m}_{total}^{\frac{3}{2}} \qquad ( 2 )$$

where Cᵣₒₜₒᵣ is a constant defined for a particular rotor topology and mₜₒₜₐₗ is the total system mass.

For solar power intake, the UAV is assumed to be oriented with its wing sections open (as in the fixed-wing state). In some embodiments, the UAV has a plank shape (0 degree angle between adjacent wing sections 30). In other optional embodiments, an angle between adjacent wing sections can be generated in the fixed-wing state. With these optional, non-limiting embodiments, solar power intake at each of the wing sections can vary as a function of the dihedral angles ϕ between adjacent wing sections 30 as illustrated in FIG. 11 that otherwise provides a simplified representation of another embodiment UAV 20′ in a fixed-wing state. With this in mind, solar power intake can be determined by Equations (3) and (4) as:

$$\begin{matrix}{P}_{solar} ( t ) = max [ 0 , I \cdot {A}_{PV} \cdot D \cdot {η}_{PV} \cdot sin ( π \cdot \frac{1}{{t}_{day}} ) ] & ( 3 ) \\ D = \frac{cos ( {φ}_{1} ) + cos ( {φ}_{2} )}{2} & ( 4 )\end{matrix}$$

where I is the peak solar irradiance, A_{PV} is the solar panel area, D is a constant that considers the angle of incidence due to the dihedrals, η_{PV} is the solar panel efficiency, and t_{day} is the length of day.

The available power in each of the three states can be determined by:

P_{avail,gnd}(t)=Pₛₒₗₐᵣ(t) (5)

P_{avail,fixed}(t)=Pₛₒₗₐᵣ(t)−P_{fixed}(mₜₒₜₐₗ) (6)

P_{avail,rotor}(t)=−Pᵣₒₜₒᵣ(mₜₒₜₐₗ) (7)

where it is assumed as a worst case analysis that no solar power is available in the rotor state. Available power can be defined as the excess solar power in a given state. For it to be utilized, it must able to be stored on-board for later use. In a deficit of solar power, power must be supplied from on-board storage (e.g., battery) to remain in the current state.

The three different states of the UAV in accordance with some embodiments of the present disclosure provide different levels of available power. Energy can be managed by transitioning between these states to ensure maximum use of available power and a minimum level of robustness. From an energy perspective, the UAV moves between higher and lower energy states. For example, rotor state flight can be thought of as a high energy state or mode because it requires stored energy and can only be maintained for a relatively short period of time. Transitioning to a lower state (e.g., rotor to fixed-wing, or rotor to ground) relaxes the energy required by the UAV.

Maximum use of available power can be achieved by avoiding the saturation of on-board energy storage. For some UAVs in accordance with principles of the present disclosure, this means transitioning to the rotor state before maximum capacity is reached. The battery's state of charge can also limit the charge rate and, as a result, limit the use of available power. It may be beneficial to set an upper energy threshold to ensure a minimum charge rate at all times.

A metric for robustness is stored on-board energy. In the event that available power is negative, for example due to flight power requirements or worsening solar conditions, stored energy can be used to transition to a lower state or maintain the current state. Similar to an upper threshold, the UAV can be configured to maintain a minimum amount of stored energy by transitioning to a lower state if the corresponding minimum energy threshold is reached. This can better facilitate a minimum level of robustness in all states, independent of the physical parameters of the UAV.

It may be useful to consider the charge or discharge time to a specified upper or lower threshold, E_{bat, thresh}, in a given state. This is given by the time t that solves the following equation:

∫ₜ_{₀}^{I}P_{avial,state}(t)dt+E_{bat}(t₀)=E_{bat,thresh} (8)

As the fixed-wing state is use for both flight and intake of available energy, it has an associated charge time t_{fixed}. The rotor state requires stored energy and has an associated discharge time tᵣₒₜₒᵣ between thresholds. An upper threshold can be assigned as the energy required for an application specific rotor operation and, as described above, a lower threshold can be used to ensure a minimum level of robustness.

Because charge and discharge times depend on solar conditions and dynamic power consumption, a more general parameter is the ration of time spent in as state as:

$${t}_{ratio , state} = \frac{{t}_{state}}{{t}_{total}} \qquad ( 9 )$$

where tₜₒₜₐₗ is the total time spend in ground, fixed-wing, and rotor states.

A majority of UAV operation is likely to occur during the period when the fixed-wing state has available power (labeled tₐᵥₐᵢₗ). In this length of time, fixed-wing level flight can be completely powered by solar and available power is stored for later use in the rotor state. To optimize for both available energy and flight time, the UAV can be configured in some embodiments to begin flight with P_{fixed} is first equivalent to Pₛₒₗₐᵣ (assuming on-board storage does not saturate before this time) and land after time tₐᵥₐᵢₗ. At the expense of stored energy, flight time can be extended before and after these points. These times and tₐᵥₐᵢₗ can be determined as:

$$\begin{matrix}{t}_{01} = \frac{{t}_{day}}{π} arcsin ( \frac{{P}_{fixed}}{I \cdot {A}_{PV} \cdot {η}_{PV}} ) & ( 10 ) \\ {t}_{02} = {t}_{day} - 2 {t}_{01} & ( 11 ) \\ {t}_{avail} = {t}_{02} - {t}_{01} & ( 12 )\end{matrix}$$

Battery Size and Payload

In some embodiments, the “Power and Energy Management” descriptions above can be used to evaluate possible battery size and UAV payload. Further, some aspects of the present disclosure relate to methods for determining a battery size for a solar-powered UAV having fixed-wing and rotor flight capabilities utilizing the Power and Energy Management algorithms.

For example, simulations for a prototype UAV in accordance with principles of the present disclosure were performed, applying algorithms above. The conceptual design parameters for the prototype design used in the simulations are provided below in Table 1. As a point of reference, an estimate of the rotor constant Cᵣₒₜₒᵣ was determined empirically.

TABLE 1

| Parameter | Value | |
|---|---|---|
| ηₚᵣₒₚ | 0.55 | |
| ρ | 1.225 | kg/m³ |
| A_{wing} | 50.41 | W/kg^{3/2} |
| Cᵣₒₜₒᵣ | 1000 | W/m² |
| η_{PV} | 0.22 | |
| A_{wing} | 0.644 | m² |
| ϕ₁ | 8.7 | degrees |
| ϕ₂ | 17.4 | degrees |

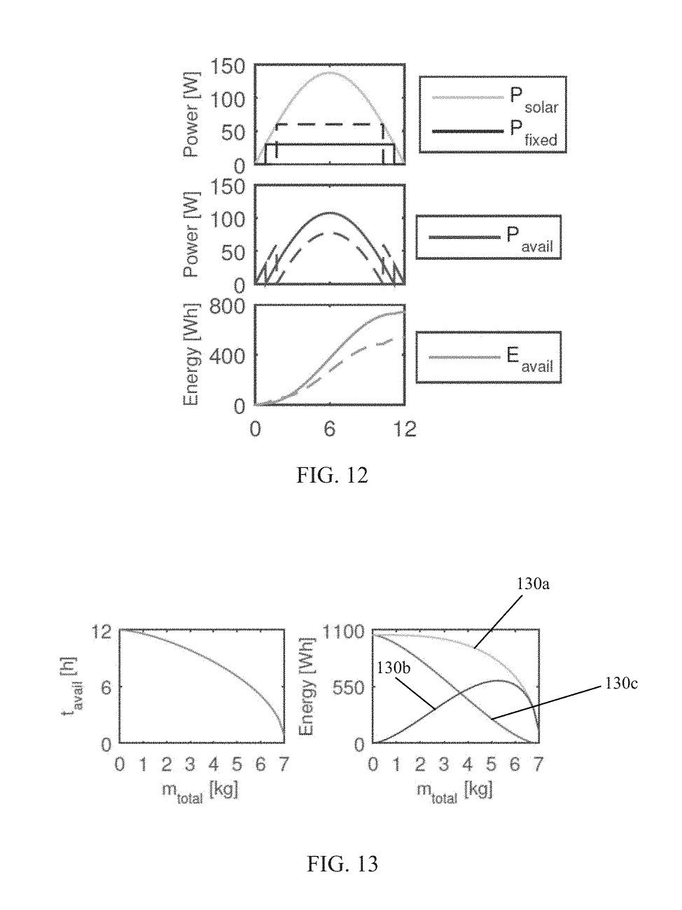

Fixed-wing performance is dependent on level flight power consumption. From the simulations, FIG. 12 presents a comparison of the available power and energy over the course of a 12-hour day with 30 W (solid lines) and 60 W (dashed lines) fixed-wing flight powers. In each instance, the UAV remains in the ground state until Pₛₒₗₐᵣ is greater than P_{fixed} to optimize for both storage of available energy and flight time. It can be seen that as P_{fixed} increases, both P_{avail, fixed} and tₐᵥₐᵢₗ decrease. This results in longer fixed-wing charge times and less overall available energy for larger payloads and batteries. If an upper energy threshold is required for rotor state operations, these operations will be less frequent. FIG. 13 presents total available flight time (tₐᵥₐᵢₗ) and fixed-wing available energy (E_{avail, fixed}) as a function of the total UAV mass from the simulations. In the energy graph of FIG. 13, line 130a represents solar energy (Eₛₒₗₐᵣ), line 130b represents energy for fixed-wing operation (E_{fixed}), and line 130c represents total available energy (Eₐᵥₐᵢₗ). It can be seen that using a larger battery to increase robustness thresholds or extend flights beyond tₐᵥₐᵢₗ will degrade fixed-wing performance. Increasing battery size results in an approximately linear decrease in available energy.

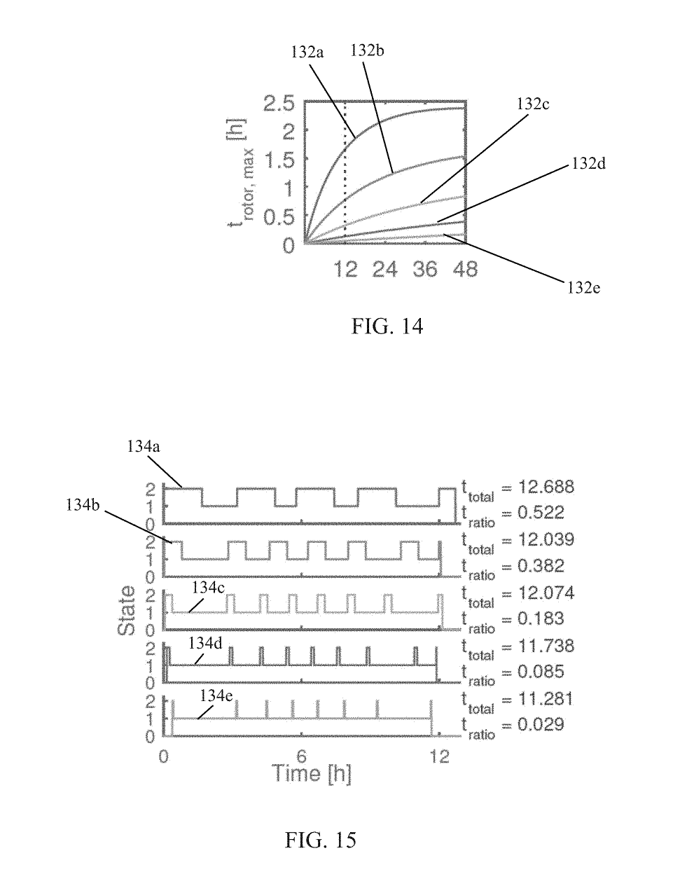

Because rotor flight entails stored power, battery size can be an important parameter for rotor state performance. FIG. 14 presents the effect of battery size (“# of NCR18650B Battery Cells”) on rotor flight time (tᵣₒₜₒᵣ) for various masses (i.e., mass of the UAV excluding battery mass or m_{aircraft}) as derived from the simulations. As a point of reference, mₜₒₜₐₗ=m_{aircraft}+m_{battery}, and simulation results are presented for m_{aircraft} values of 1.00 kg (plot line 132a), 2.00 kg (plot line 132b), 4.00 kg (plot line 132c), 8.00 kg (plot line 132d), and 16.00 kg (plot line 132e). With the analysis presented in FIG. 14, Pᵣₒₜₒᵣ was assumed constant. The transition between fixed-wing and rotor state is governed by the upper and lower energy storage thresholds. In this simulation, the thresholds were set to the minimum and maximum energy capacity of the battery. It can be seen that for the simulated UAV mass and payloads, increasing battery size increases rotor flight time with diminishing returns. This means a small increase in rotor flight time requires a longer fixed-wing charge time. In other words, the proportion of total flight time in rotor state because smaller with increasing battery size. FIG. 15 presents results from the simulations of the state of each UAV from the simulations of FIG. 14, at the operating point of twelve battery cells over the course of a 12-hour day. In the plots of FIG. 15, the UAV or aircraft states are represented by 0=ground, 1=fixed-wing, and 2=rotor; tᵣₐₜᵢₒ is the ratio of total flight time (tₜₒₜₐₗ) spent in the rotor state. For each UAV or aircraft simulation, once the corresponding t₀₂ was reached, the aircraft transitioned to the rotor state until the remaining stored energy was depleted. Simulation results are presented for m_{aircraft} values of 1.00 kg (plot line 134a), 2.00 kg (plot line 134b), 4.00 kg (plot line 134c), 8.00 kg (plot line 134d), and 16.00 kg (plot line 134e). It can be seen that increasing m_{aircraft} for a given battery size decreases tₜₒₜₐₗ, t_{ratio, rotor}, and tᵣₒₜₒᵣ. Methods in accordance with principles of the present disclosure include selecting a battery sized from the maximum m_{aircraft} and tᵣₒₜₒᵣ required by a specific application.

Electrical Hardware and Control

Returning to FIGS. 1A and 1B, in some embodiments the UAVs of the present disclosure include electrical hardware (e.g., modules) and one or more controllers configured or programmed to effectuate control over various performance parameters and/or operations, such as, for example, automated transitioning between the rotor and fixed-wing states (e.g., prompted operation of the hinge assembly actuators described above), power management, solar collection management, other actuators, flight guidance, etc. Thus, one or more (including all) of the wing sections 30 can include or carry one or more electrical hardware components, such as, but not limited to, a maximum power point tracker (MPPT) module, and electronic speed controller (ESC), a variable pitch propeller (VPP) controller (e.g., servo controller), a battery management system (BMS), a controller programmed to control flight operations (e.g., a Pixhawk autopilot), GPS, airfoil controller (e.g., servo controller), etc. In some related embodiments, the UAV 20 can be configured such that electrical hardware component(s) carried by one wing section 30 electrically communicate with component(s) of other wing sections 30.

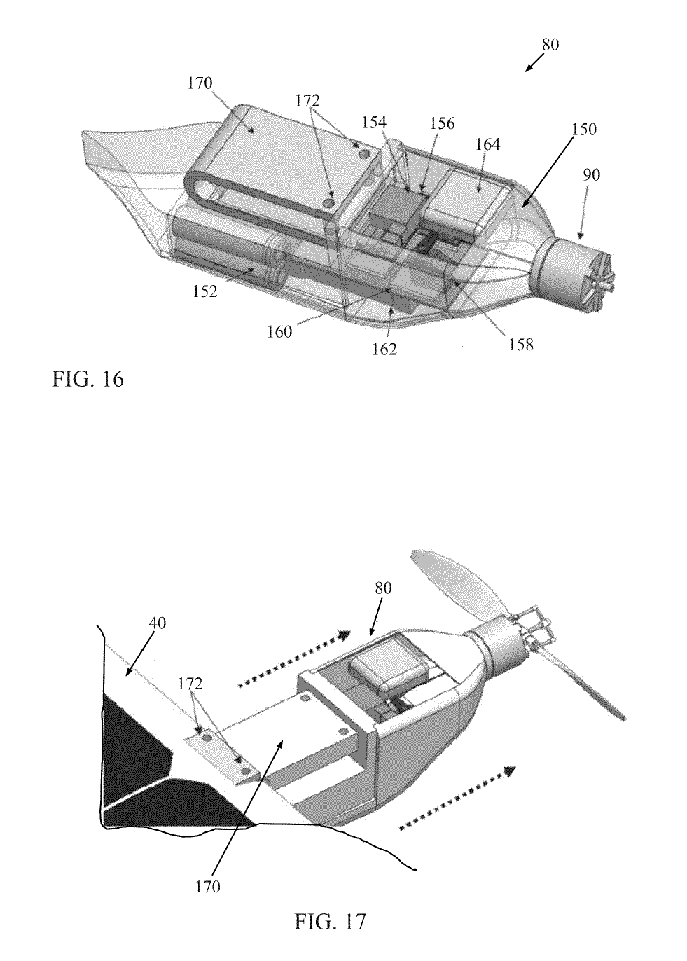

With the above in mind, in some embodiments each of the wing sections 30 is provided with a similar or substantially identical configuration of power electronics and batteries. Within each of the wing sections 30, the placement of components is such that, in some embodiments, the center of gravity lies at the longitudinal mid-section to improve stability in both the fixed-wing and rotor states. It will be recalled from the discussions above with respect to FIG. 7 that the component module or pod 80 can be provided that houses or provides various electrical hardware components. The optional component module 80 is shown in greater detail in FIG. 16 and can include a housing 150 (drawn transparent for ease of understanding) maintaining a battery(ies) 152 along with various electrical hardware components such as an MPPT 154, an ESC 156, a VPP 158, a BMS 160, a flight controller 162 (e.g., Pixhawk autopilot), and a GPS 164. Electrical connections between two or more of the module components (as well as across wing sections) can be provided in manners known to those of ordinary skill. With additional reference to FIGS. 1A and 1B, the identical component module 80 can be provided for each of the wing sections 30. In other embodiments, one or more of the components 154-164 can differ between wing sections 30a-30d. For example, in one non-limiting embodiment, the component module 80 as shown in FIG. 16 is provided with the inner, second and third wing section 30b, 30c, whereas the component module or pod 80 provided with the outer, first and fourth wing sections 30a, 30d replaces the flight controller 162 and the GPS 164 with a servo motor or controller adapted or programmed for driving the airfoil lift surfaces (e.g., the reflexed tail 72). With this optional construction, then, the UAV 20 includes two flight controllers 162 (one programmed to dictate flight control in the fixed-wing state and the other programmed to dictate flight control in the rotor state) and four lift servo motors (one for each of the four wing sections 30). One or more additional hardware components or sensors can also be provided with one or more of the component modules 80 as described below. Further, additional space inside of the housing 150 can provide flexibility with regard to center of gravity placement.

In addition to providing desirable electrical hardware components, the component module or pod 80 can be designed to be removably assembled to the corresponding airfoil 40 via a frame mount 170 provided with the housing 150. As represented by FIG. 17, the frame mount 170 facilitates ready coupling and un-coupling of the component module 80 with the airfoil 40, for example using one or more fasteners 172. With this optional construction, the component module 80 is easily customizable by an end user. Optional examples of these modular constructions are described in greater detail below.

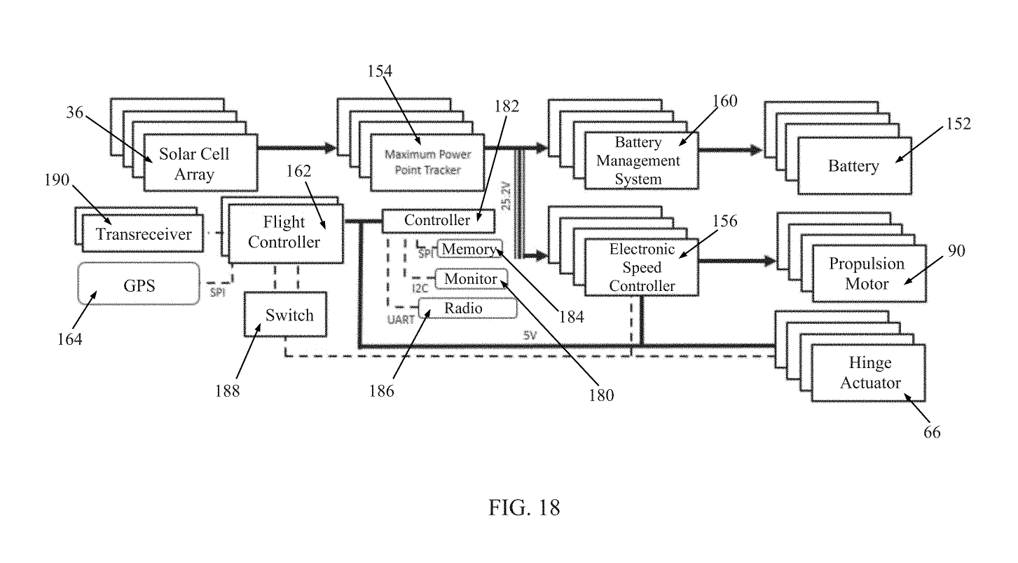

FIG. 18 illustrates the hardware topology of one embodiment of a UAV in accordance with principles of the present disclosure that incorporates exactly four of the wing sections 30 (FIG. 1A) as described above. As shown, each wing section is provided with an array of the solar cells 36 (e.g., eight SunPower C60 solar cells). A respective one of the maximum power point trackers (MPPT) 154 is provided with, and dedicated to the solar cells of, each of the wing sections 30. Due to the I-V characteristics of solar cells, the impedance of the load is desirable closely matched with the output impedance of the solar cell array. By providing each wing section 30 with a dedicated MPPT 154, the varied angle of solar irradiance hitting each angled section of the UAV (in the fixed-wing state) can be addressed. Each MPPT 154 is used to track and adjust the voltage operating point of its corresponding panel to ultimately maximize the amount of solar power available to the UAV. The MPPT or MPPT module 154 can operate on programming as known in the art, or can be customized as described below.

FIG. 18 further reflects that each of the wing sections includes at least one of the batteries 152. The batteries 152 can be of any format useful for powering the propulsion unit 40 (FIG. 1A), and can include one or more lithium-ion cells (e.g., six lithium-ion batteries available from Panasonic under the trade designation NCR18560b). Each of the lithium ion cells is optionally monitored by a dedicated battery management systems (BMS) 160 (optionally designated as a Li-ion protection circuit) to protect against over-voltage and unbalanced cells.

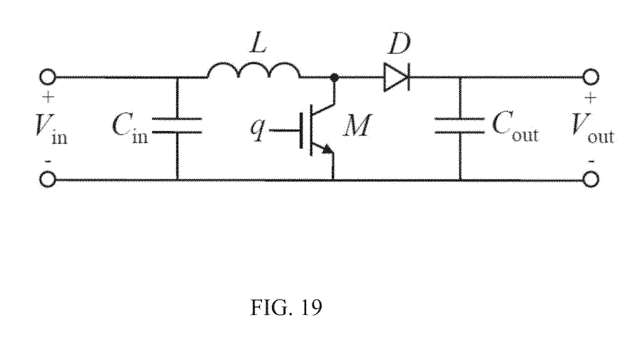

The propulsion unit motor 90 provided with each wing section is represented in FIG. 19; power to the respective motor 90 is regulated by the corresponding electronic speed controller (ESC) 156. The ESC 156 can assume a variety formats known to those of ordinary skill, and can include, for example an ESC available from Turnigy under the trade designation Plush 25A. A power monitor 180 can be provided to monitor power throughout the UAV, and can assume various forms known in the art, such as a current shunt and power monitor available from Texas Instruments under the trade designation INA219. Each wing section module communicates (e.g., over a 12C bus) with a controller 182 that can assume various forms known in the art, such as a 8 bit microcontroller available from Atmel under the trade designation ATmega 328. Voltage and current measurements received by the controller 182 are optionally stored locally on a memory 184 (e.g., SD card), and can optionally be relayed in real-time via a radio 186 (e.g., 915 MHz radio) to a ground station.

As mentioned above, in some embodiments, two of the flight controllers 162 (e.g., Pixhawk autopilot flight controller) are provided to control the UAV. In some embodiments a switch 186 is provided to switch throttle control of the four electronic speed controllers 156 between the two flight controllers 162. The switch 188 can assume various forms known in the art, and can include, for example a 4 channel PWM multiplexer. A transreceiver 190 (e.g., a Spektrum DSMX transmitter and receiver combination) can be provided to perform teleoperation of the UAV. The optional GPS 164 is shown in FIG. 18, and can be utilized, for example, to set the UAV to fly to prescribed GPS way points. Finally, the flight controllers 162 are electrically connected to each of the hinge assembly actuators/servos 66. The flight controllers 162 optionally use a single PWM signal to control all four hinge assembly servos 66, and can be configured to be remotely controlled by a toggle switch provided with the transreceiver 190.

The hardware topology of FIG. 18 is one exemplary embodiment envisioned by the present disclosure, and a wide variety of other configurations are also acceptable. It will be recognized that in many applications, the sole purpose of power electronics is to efficiently convert from one form of power to another. For this reason, there are many off-the-shelf solutions that can be readily incorporated into existing UAV systems. However, even with this large selection, it can be difficult to find an effective solution when the power electronics are an integral part of system operation as with some embodiments of the present disclosure. In solar-powered aircraft, especially those designed for long-term autonomous operation, it may be beneficial for the UAV control system to be “energy aware” and change its behavior in order to maximize the availability of solar power. In some embodiments, the UAVs of the present disclosure interconnect one or more modules or hardware components across the wing sections 30 (FIGS. 1A and 1B), facilitating, for example, the MPPT module 154 of each wing section 30 to not only efficiently track and manage solar power, but also communicate with other system modules. Shared information can be used to more closely optimize performance and make predictions about future conditions. For example, solar availability data could be incorporated into path planning and UAV orientation could be used to more closely optimize MPPT algorithms.

To avoid power tracking issues associated with solar cells experiencing non-uniform solar irradiance, the solar cells can be wired in series with neighboring solar cells on individual wing sections. While it may be acceptable to use a single MPPT on a fixed-wing UAV where the dihedral angles are relatively small, in some embodiments of the present disclosure, the maximum power point (MPP) for each wing section panel is independently tracked as described above. This optional configuration can facilitate a modular construction of the UAVs of the present disclosure, and can be implemented by formatting the MPPT printed circuit board (PCB) to have a small form factor in order to fit in the wing section component module (e.g., the component module 80 (FIG. 16)) housing.

MPPT Hardware Design

In some embodiments, the UAVs of the present disclosure can incorporate a customized MPPT module. With these optional embodiments, the hardware of the MPPT can depend on the input/output voltages and currents of the system. Certain hardware considerations can be based upon a comparison of solar array input voltage with discharged battery voltage. By way of non-limiting example, each wing section of an exemplary UAV may have or carry eight solar cells (e.g., SunPower E60 cells) connected in series, with a resultant maximum expected MPPT input voltage and current of 5.84 V and 6.17 A, respectively. Further, in some non-limiting examples, each wing section may have or carry eight li-ion batteries (e.g., Panasonic NCR18650B) in a 2p4s configuration. With these optional constructions, then, the MPPT output voltage would range from 8.4 V (minimum charge) to 16.8 V (maximum charge). Under these circumstances, because the input voltage of the solar array is lower that the discharged battery voltage, a standard (non-synchronous) boost topology can be selected for simple control (low-side gate drive) and small PCB footprint. An example of an appropriate boost converter is schematically shown in FIG. 19 in which signal q is that gate drive signal, determining the switching frequency (1/Ts) and duty ratio (d) of the converter. With the booster converter of FIG. 19, M is a transistor; D is a diode. The input and output design parameters can further dictate the desired component values and minimum voltage/current ratings of the MPPT hardware.

The gate signal q can be driven by a low-side gate driver. The signal can be provided by an appropriate microcontroller running an MPPT tracking algorithm. Optional MPPT tracking algorithms are described in greater detail below. The microcontroller's on-board analog-to-digital converters (ADCs) can be used to measure both input and output voltages as well as current (e.g., via a current sense amplifier). The measured values can be used by the selected tracking algorithm to determine the MPP of a solar panel. In particular, the duty ratio d can be selected to match the input equivalent resistance of the MPPT with the output resistance of the solar panels.

In other embodiments, the MPPT hardware design and construction can have other forms or formats that may or may not incorporate the boost converter topology described above.

MPPT Algorithm

In some embodiments, an algorithm employed by the MPPT module(s) is designed to maximize the power out of a solar array by adjusting the operating voltage at the terminals of the solar array. The most common tracking method is perturb and observe (P&O) due to its simplicity and ease of implementation. The P&O method operates as follows: the solar panel voltage is perturbed by adjusting the duty cycle of the boost convertor; if the output power increases, the voltage is perturbed again in the same direction, otherwise it is perturbed in the opposite direction. Each perturbation of the duty cycle is called a step. Optional MPPT algorithms of the present disclosure can incorporate a fixed step (FS) or adaptive step (AS) P&O approach.

FS size is generally viewed as being simpler and easy to implement. FS has a fixed duty cycle step size (Δd) that makes tuning straightforward; however, FS may require a trade-off between response time and MPP power loss. A large step size gives fast convergence, but results in power loss due to oscillations around the MPP. To minimize oscillation losses, the smallest step size (Δdₘᵢₙ) that results in a ΔV greater than the ripple voltage can be used.

An AS size attempts to remedy the issues of fixed step by scaling the step size with the derivative of power with respect to voltage and a scaling factor as:

$$Δ d = N \frac{Δ P}{Δ V} \qquad ( 13 )$$

where Δd is the step size, ΔP is the change in power, and ΔV is the change in solar panel voltage. The selected scaling factor can be tuned for optimal performance.

Modular Constructions

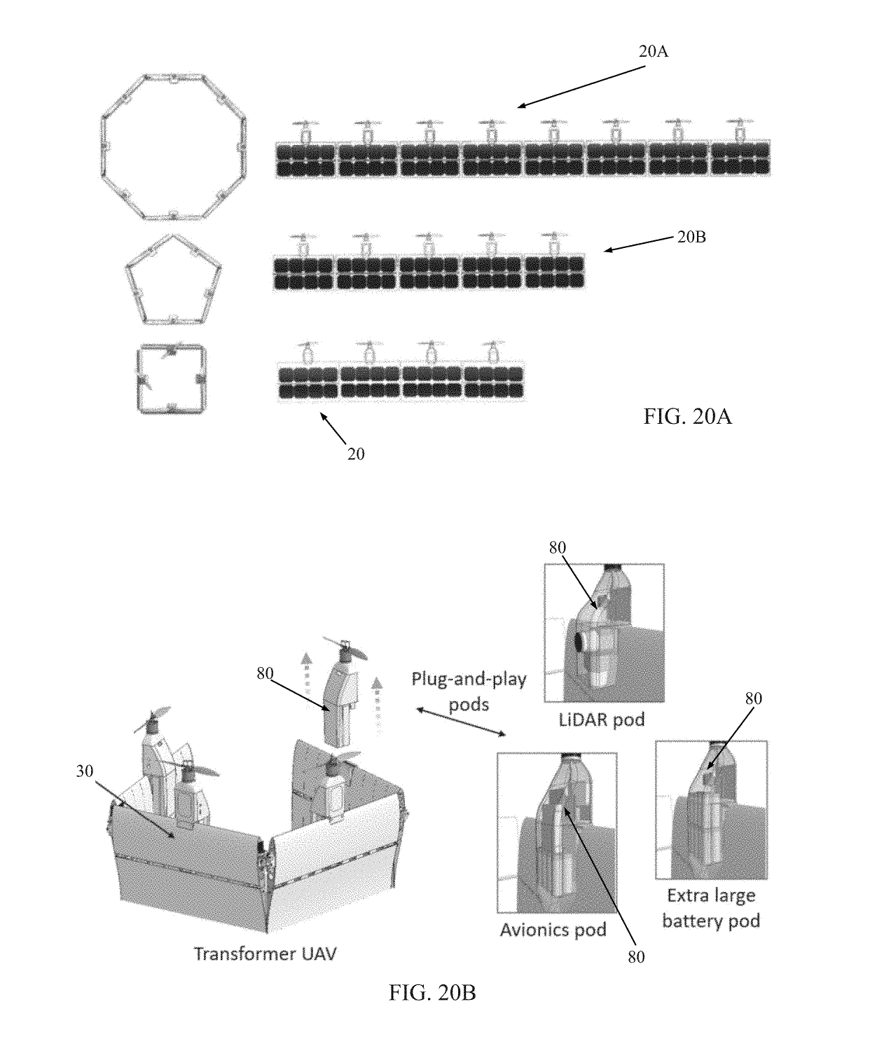

In some embodiments, the UAVs of the present disclosure can have a modular construction, for examples in terms of one or both of the number of wing sections and/or the component module utilized with each wing segment. To facilitate a wide range of application and task needs, the UAVs of the present disclosure can optionally have the modularized wing section construction illustrated in FIG. 20A. Each wing section 30 can be composable in the sense that additional wing sections 30 can be added to the structure. With this modular construction, additional ones of the wing sections 30 are readily connected to the UAV 20 described above, resulting in other UAVs (e.g., UAV 20A, UAV 20B, etc.) constructions that represent larger airframes capable of greater performance in terms of, for example, flight endurance and payload carrying capability.

In addition or alternatively, the component module or pod 80 constructions mentioned above can be employed as shown, for example, in FIG. 20B. The pods 80 can be 3D printed using low cost, commercially available FDM 3D printers, and the pod design can be customized for application-specific needs. In some embodiments, the pods are used as the enclosures for the propulsion system, and a heterogeneous array of sensors can be equipped to the platform to optionally perform simultaneous sensing and monitoring tasks.

In the event that a single UAV is unable to support all the necessary sensors for an application, multiple UAVs can be used in a distributed network, individually supporting tasks such as ground sensing, 3D reconstruction, manipulation, processing and communication. Teams of transformable UAVs can have the functionality of augmenting capabilities, such as alternating vehicle state: when one UAV needs to transform into fixed-wing to recharge on-board batteries, another UAV can replace its role in the rotor state. Also, differently-sized UAVs can operate in a co-robot environment to achieve prescribed tasks.

### Examples

Objects and advantages of the present disclosure are further illustrated by the following non-limiting examples and comparative examples. The particular components and materials recited in these examples, as well as other conditions and details, should not be construed to unduly limit the present disclosure

Propulsion Unit with Variable Pitch Propeller

The optional variable pitch propeller propulsion units of the present disclosure (e.g., the propulsion unit 100 of FIG. 11) were evaluated via a numerical simulation. The core of the simulation was executed by QPROP, a propeller analysis tool developed by M. Drela (http://web.mit.edu/drela/Public/web/qprop/qprop.theory.pdf; 2006). MATLAB code was written to prepare flight simulation scenarios, send and receive data from QPROP, and organize the resulting aerodynamic information into graphical form. During formulation of the flight scenarios, it was assumed that air was at standard temperature and pressure, and that atmospheric air speed was zero with respect to an inertial reference frame. A level-flight dynamics model was developed according to I. Waitz (http://ocw.mit.edu/ans7870/16/16.unified/propulsionS04/UnifiedPropulsion4/UnifiedPropulsion4.htm; 2003) and aircraft drag was estimated with XFOIL, an airfoil analysis tool.

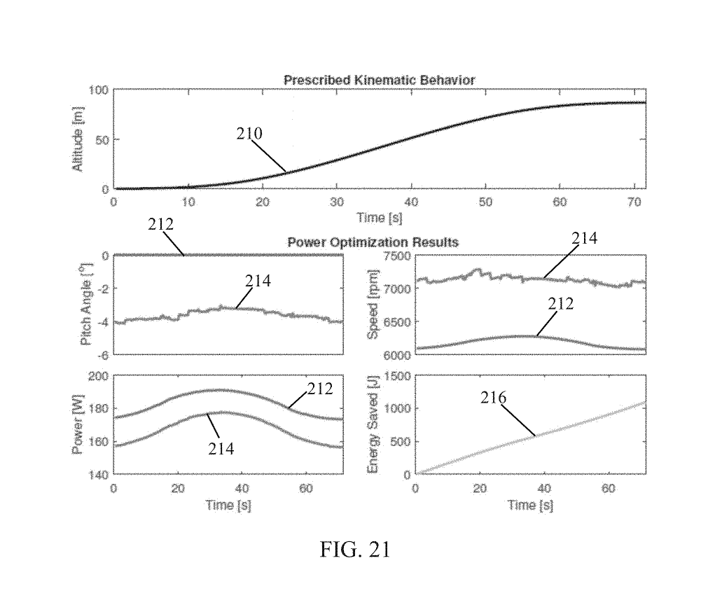

Simulations were performed based upon the UAV configuration of FIGS. 1A and 1B (i.e., four wing sections each with an airfoil and a propulsion unit) in performing a simple sequence of altitude commands in the rotor state. Required thrust was assumed to be split equally among four motor-propeller pairs. The UAV weight was designated as 4.93 kg. The electrical input power for the motor of each propulsion unit was obtained by applying a model of an electric motor available from Tiger Motors under the trade designation MT28174 KV770 into QPROP to calculate input electrical power. Fixed-propeller and variable pitch propeller simulations were run. For the fixed pitch propeller unit simulation, a model of an off-the-shelf propeller (available from APC under the trade designation 10x4.7SF) was utilized. For the variable pitch propeller simulation, the pitch angle of the propeller was varied in order to converge on a solution which satisfied the kinematic constraints at the minimum value of P_{shaft} (the mechanical power of the motor output shaft). Control of the variable pitch propeller was modeled such that the optimum offset angle could be resolved instantaneously to better than 0.1°. FIG. 21 shows the results of simulations, including aircraft altitude (plot line 210), fixed pitch propeller (plot lines 212), variable pitch propeller (plot lines 214) and saved energy (plot line 216). As a point of reference, the noise seen throughout the second row of plots in FIG. 21 is due to the implementation of the global Newton method QPROP uses to solve the system of equations modeling the propeller.

While shaft power is the quantity that can be used to describe when the propeller is performing optimally, the amount of energy drawn from electrical power describes the overall efficiency of the propulsion system. The bottom-right frame of FIG. 21 shows the amount of electrical energy that the variable pitch propeller saves as compared with the energy used by the fixed-pitch propeller as determined by:

E_{saved}=∫ₜ_{₀}^{t}(P_{fixed}−P_{variable})dt (14)

where P_{fixed} is the electrical power consumed by the propulsion system with the fixed-pitch propeller, and P_{variable} is the electrical power consumed by the same system under a variable pitch propeller configuration.

Under the conditions specified, the average power savings in the rotor state is over 17 W per motor, leading to an overall savings of almost 70 W for a quad-rotor configuration, or about a 10% reduction in power consumption for hover. Simulations were also run in order to calculate the amount of power saved in level flight. The average power savings in level flights was almost 15 W per motor, which translates to approximately a 50% reduction in level-flight power utilizing a variable pitch propeller design as compared with the level-flight power under a fixed-pitch propeller simulation.

To further evaluate the optional variable pitch propeller propulsion units of the present disclosure (e.g., the propulsion unit 100 of FIG. 9), a testbed was designed and constructed to perform tests under the static thrust case. Sheets of laser-cut acrylic were assembled to make a class-three lever to measure thrust applied at the end of the arm. A Himax HC2816-0890 outrunner motor was paired with a pushrod-style variable pitch assembly available from Maxx Products International under the trade designation VPP101 Pro. An APC 10x4.7SF propeller was modified to attach to the variable pitch assembly, and a digital servo motor (S3156 servo motor from Futaba) was used to actuate the blade pitch. Thrust was measured by resting the level arm on a load cell (TAL201 10 kg load cell from HT Sensor Technology Co.), and the pitch of the propeller was calculated via the servo angle by measuring the commanded position of the servo motor. Voltage across the motor was obtained by recording the pulse width of the throttle signal into the electronic speed controller. Power consumption was measured by using a MAX9611 current sense amplifier (from Maxim Integrated), and motor speed was measured with a custom-built infrared tachometer. These sensors were interfaced with an Atmega328P microcontroller (from Atmel) and sensor data was stored on a microSD card.

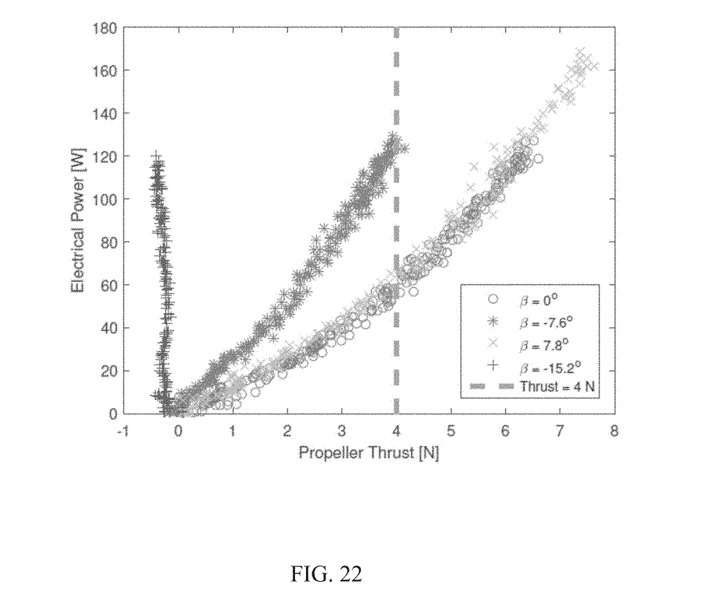

With the above testbed construction, a succession of tests were performed under static thrust conditions to approximate hover (rotor state) in a UAV of the present disclosure with four wing sections each with a airfoil and propulsion unit. The results are reported in FIG. 22 and illustrates the influence of the blade pitch offset angle β on the ability of a propulsion system to efficiently produce thrust in a given flight condition. The ratio of thrust to electrical can be seen in FIG. 22 to be a strong function of the propeller pitch angle, able to provide factor-of-two reductions in power consumption in certain cases. Such flexibility in the propulsion system can allow power to be efficiently converted into thrust across the entire flight envelope.

MPPT

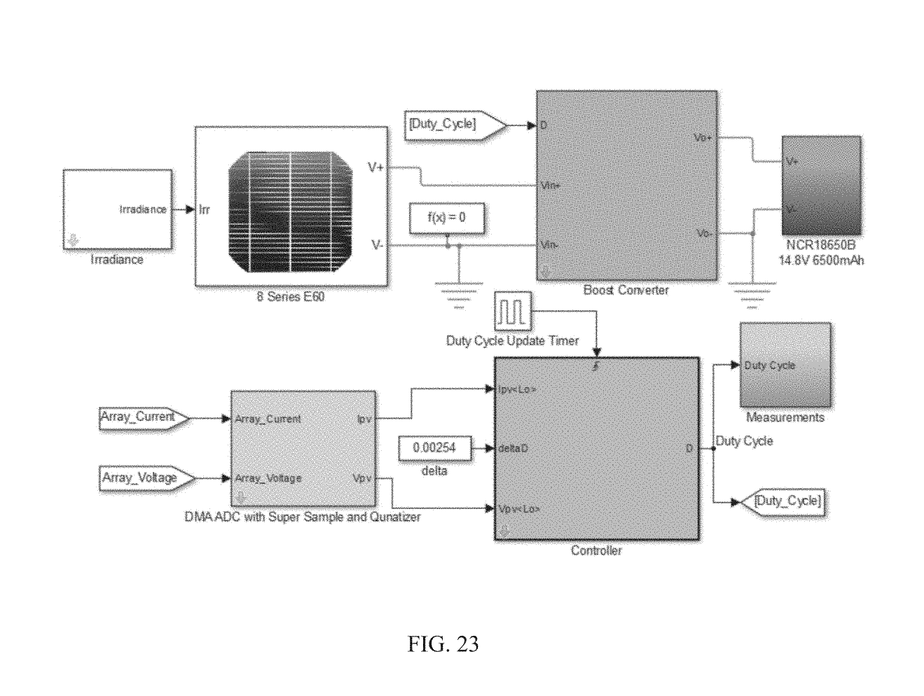

The optional custom MPPT of the present disclosure and described above was evaluated by modeling a solar array, custom MPPT, and battery system for one wing section using SimElectronics libraries in Simulink. The simulated system consisted of 9 series connected SunPower E60 solar cells, 8 Panasonic NCR18650B batteries connected in a 2p4s configuration, and the custom MPPT modeled with non-ideal components. The tracking algorithm was implemented using a timed controller that ran and updated the duty cycle every 1 ms. Additionally, the controller sampled the array voltage and current in a super-sample method as the average of two 12-bit quantized samples of the array voltage and current taken 150 μs apart. A super-sample was taken every 239 μs. The Simulink block diagram is shown in FIG. 23.

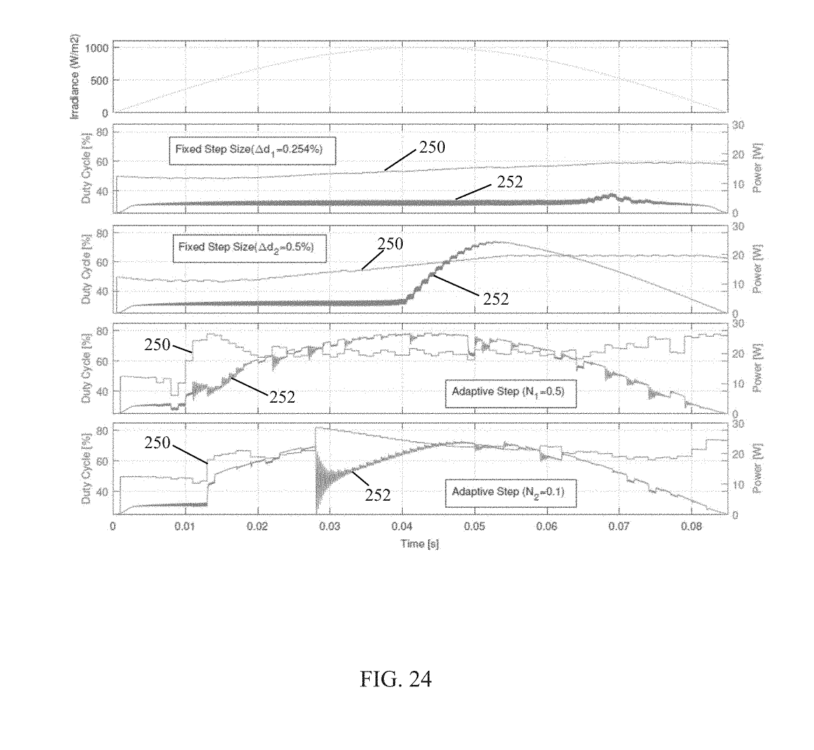

Four simulations were run to represent different MPPT perturb and observe tracking methods: 1) Fixed step (FS) with 0.254 step size; 2) FS with 0.5 step size; 3) adaptive step (AS) with 0.1 scaling factor; and 4) AS with 0.5 scaling factor. The algorithms were simulating in dynamic irradiance conditions that correspond to a worst-case scenario of a four wing section UAV in the rotor state turning 180° on its z axis in 85 ms. The results of each simulation are provided in Table 2 and FIG. 24. In the graphs of FIG. 24, trace 250 corresponds with the duty cycle and trace 252 correspond with power.

TABLE 2

| | Net Energy (J) from dynamic |
|---|---|
| Simulation | irradiance over 85 ms |
| FS (Δd₁ = 0.254%) | 0.2746 |
| FS (Δd₂ = 0.5%) | 0.7813 |
| AS (N₁ = 0.5) | 1.3216 |
| AS (N₂ = 0.1) | 1.1866 |

Table 2 indicates that the FS (Δd₁=0.254%) algorithm cannot respond fast enough, and, although FS (Δd₂=0.5%) was able to collect three times more energy, both AS algorithms collected at least five times more energy. While it is unlikely that solar irradiance will be as volatile in practice as in simulation, maximizing energy collection in dynamic conditions can be important due to the flight characteristics of a transformable UAV. Furthermore, flight data could be integrated into the power tracking system through adjusting the sensitivity of an AS algorithm through the scaling factor N described above.

Although the present disclosure has been described with reference to preferred embodiments, workers skilled in the art will recognize that changes can be made in form and detail without departing from the spirit and scope of the present disclosure.

What is claimed is:

1. An unmanned aerial vehicle comprising:
a plurality of wing sections each including:
an airfoil,
a propulsion unit,
wherein the wing sections are consecutively arranged side-by-side; and
a plurality of hinge assemblies;
wherein respective ones of the hinge assemblies pivotably connect immediately adjacent ones of the wing sections to define an airframe module;
and further wherein the airframe module is transitionable between:
a fixed-wing state in which the airframe module has an elongated shape extending between opposing, first and second ends, the first end defined by a side of a first wing section of the plurality of wing sections and the second end defined by a side of a second wing section of the plurality of wing sections, and
a rotor state in which the side of the first wing section is immediately proximate the side of the second wing section.

2. The unmanned aerial vehicle of claim 1, further comprising a plurality of modular pods each including a propulsion unit, and further wherein respective ones of the modular pods are mountable to an airfoil to form a corresponding one of the plurality of wing sections.

3. The unmanned aerial vehicle of claim 1, wherein each of the wing sections further includes a plurality of photovoltaic cells maintained by the corresponding airfoil frame.

4. The unmanned aerial vehicle of claim 1, wherein the plurality of wing sections further includes a third wing section immediately adjacent the first wing section, and the plurality of hinge assemblies includes a first hinge assembly pivotably connected the first and third wing sections, and further wherein the unmanned aerial vehicle further includes an actuator linked to the first hinge assembly and operable to articulate the first and third wing sections relative to one another in transitioning between the fixed-wing and rotor states.

5. The unmanned aerial vehicle of claim 4, wherein the first hinge assembly includes a servo driven four-bar linkage mechanism.

6. The unmanned aerial vehicle of claim 1, further comprising a plurality of actuator assemblies, wherein respective ones of the actuator assemblies are linked to a respective one of the plurality of hinge assemblies.

7. The unmanned aerial vehicle of claim 6, further comprising a controller carried by the airframe module, wherein the controller is electronically connected to each of the plurality of actuator assemblies and is programmed to prompt operation of the plurality of actuator assemblies to automatically transition the airframe module between the fixed-wing and rotor states.

8. The unmanned aerial vehicle of claim 1, wherein the plurality of wing sections includes exactly four wing sections, and further wherein with operation of the propulsion units in the fixed-wing state, the unmanned aerial vehicle experiences flight as fixed wing aircraft, and even further wherein with the operation of the propulsion units in the rotor state, the unmanned vehicle experiences flight as quad-copter.

9. The unmanned aerial vehicle of claim 8, wherein the propulsion unit of each of the plurality of wing sections includes a propeller, and further wherein the airframe module is configured such that the propellers of immediately adjacent ones of the wing sections rotate in opposite directions.

10. The unmanned aerial vehicle of claim 1, wherein the propulsion unit of the first wing segment includes a motor and a propeller rotatably driven by a shaft of the motor, and further wherein a pitch of the propeller relative to the motor shaft is variable.

11. The unmanned aerial vehicle of claim 10, wherein the propulsion unit of the first wing segment further includes a propeller pitch control mechanism operable to alter the pitch of the propeller relative to the motor shaft.

12. The unmanned aerial vehicle of claim 1, wherein the propulsion unit of the first wing segment includes a housing supporting a motor and a propeller rotatably driven by a shaft of the motor, and further wherein the housing is releasably mounted to the corresponding airfoil frame.

13. The unmanned aerial vehicle of claim 12, wherein a connection between the propulsion unit and the airfoil frame of the first wing section permits the housing to be selectively secured to the airfoil frame at a plurality of locations relative to a leading end of the airfoil frame, and further wherein a center of gravity of the first wing section is varied as a function of the selected location of the housing relative to the leading end.

14. The unmanned aerial vehicle of claim 1, wherein each wing section further includes at least one battery, a plurality of photovoltaic cells and a maximum power point tracker (MPPT) module.

15. The unmanned aerial vehicle of claim 14, further comprising a controller electronically connected to and controlling operation of each of the MPPT modules.

16. The unmanned aerial vehicle of claim 15, wherein the controller is an autopilot controller carried by one of the plurality of wing sections.

17. The unmanned aerial vehicle of claim 1, wherein the unmanned aerial vehicle is configured to self-perform a transition from the rotor state to the fixed-wing state while airborne, and to self-perform a transition from the fixed-wing state to the rotor state while airborne.
